(19) United States
(12) Patent Application Publication
(10) Pub. No.: US 2025/0010657 A1
(43) Pub. Date: Jan. 9, 2025

(54) HUB-BEARING UNIT FOR A WHEEL OF A MOTOR VEHICLE

(71) Applicant: AKTIEBOLAGET SKF, GOTEBORG (SE)

(72) Inventors: Giancarlo BRANCA, Rivoli (IT); Marco ROMANETTO, Pianezza (IT); Fulvio Carlo NICASTRI, Garzigliana (IT); Alessandro FERRERO, Torino (IT)

(21) Appl. No.: 18/755,846

(22) Filed: Jun. 27, 2024

(30) Foreign Application Priority Data
Jul. 4, 2023 (IT) 102023000013896

(51) Int. Cl. B60B 27/00

(52) U.S. Cl. CPC B60B 27/0026; B60B 27/0005; B60B 27/0094

(57) ABSTRACT

A hub-bearing unit includes a stationary radially outer ring and a rotatable hub having an axially extending tubular portion at an axially inner side and a radially outwardly extending toothed profile. A portion of the hub is located radially inside the radially outer ring. A radially inner ring is mounted on the hub, and a toothed sleeve is mounted axially inward of the radially inner ring and has a radially inner surface including at least one groove mating with the toothed profile. The tubular portion includes a radially outer cylindrical surface, an axial portion of the radially inner surface of the toothed sleeve lies on or is bounded by a first imaginary cylinder, the axial portion of the radially inner surface engages the radially outer cylindrical surface, and the first imaginary cylinder and the radially outer cylindrical surface are coaxial.

### CROSS-REFERENCE

This application claims priority to Italian patent application no. 102023000013896 filed on Jul. 4, 2023, the contents of which are fully incorporated herein by reference.

### TECHNOLOGICAL FIELD

The present disclosure is directed to a hub-bearing unit for a wheel of a motor vehicle. The unit comprises a bearing unit coupled removably to a constant velocity joint and is therefore suitable for use both in a drive wheel and in a driven wheel.

### BACKGROUND

Known hub-bearing units include a flanged rotary hub mechanically connected to a rotary element of the motor vehicle, for example the wheel or the disc of a braking element, while the bearing unit comprises an outer ring, a pair of inner rings, one of which may be the flanged hub itself, and a plurality of rolling elements, for example balls. All of these components have axial symmetry about the rotation axis of the rotary elements, for example the flanged hub and the inner rings of the bearing unit.

The flanged hub receives the drive torque from the bellhousing of the constant velocity joint via a splined coupling. In particular, the bellhousing of the constant velocity joint is provided with an axially outer toothing, while a toothed sleeve with axially outer toothing is fastened to the hub. The toothed sleeve and the hub are coupled to each other by an internal groove of the toothed sleeve that engages with a toothed profile of the hub.

A ring gear with axially inner toothing transmits motion from the constant velocity joint to the hub of the wheel, and the ring gear is provided with a mechanism for disconnecting it from the toothed sleeve of the hub. Consequently, when the ring gear is engaged with the toothed sleeve of the hub, motion is transmitted from the transmission shaft to the wheel of the motor vehicle, which then acts as a drive wheel. Conversely, when the ring gear is disengaged from the toothed sleeve of the hub, transmission of motion from the transmission shaft to the wheel is interrupted, and the wheel acts as a driven wheel.

In this configuration, bearings are required between the hub and the constant velocity joint to enable the hub to rotate independently of the constant velocity joint. These bearings are typically of the radial ball bearing type.

By means of a known process such as orbital roll forming, an axially inner end of the flanged hub is deformed to axially preload and clamp both the toothed sleeve and the radially inner ring (mounted on the flanged hub) with respect to the flanged hub itself.

The coupling and the centering between the toothed sleeve and the hub is obtained by engaging the internal groove of the toothed sleeve with the outer toothed profile of the flanged hub. Effective centering between the two components is thus not ensured because a certain degree of play between the internal groove of the toothed sleeve and the toothed profile of the hub is required. The play is dependent on the manufacturing precision (tolerance class), is defined by the specifications of the groove standards (for example ANSI B92.1, DIN 5480 or others) and is equal to a radial space between the engaging profiles of the two grooves. This play may lead to the radial movement of the toothed sleeve with respect to the hub during the assembly operation, before and during the orbital roll forming operation. The subsequent eccentricity of the toothed sleeve with respect to the hub causes subsequent problems in the engagement between the toothed sleeve and the ring gear connected to the constant velocity joint, and also vibrations and/or noise during the period in which the disconnection system is inserted.

### SUMMARY

The present disclosure is directed to a hub-bearing unit coupled to a system for disconnecting from the transmission shaft in which the hub comprises a cylindrical surface which is coupled to a respective discontinuous or continuous cylindrical surface of the toothed sleeve.

One aspect of the present disclosure is a hub-bearing unit having a rotation axis, a stationary radially outer ring and a hub. The hub has a radially outwardly extending flange at an axially outer side and an axially extending tubular portion at an axially inner side and a radially outwardly extending toothed profile at the tubular portion. A portion of the hub is located radially inside the radially outer ring, and the hub is rotatable relative to the radially outer ring about the rotation axis. A radially inner ring is mounted on the hub in axial abutment with a radial external shoulder of the hub, and a toothed sleeve is mounted axially inward of the radially inner ring and has a radially inner surface including at least one groove mating with the toothed profile. The tubular portion includes a radially outer cylindrical surface, an axial portion of the radially inner surface of the toothed sleeve lies on or is bounded by a first imaginary cylinder, the axial portion of the radially inner surface engages the radially outer cylindrical surface, and the first imaginary cylinder and the radially outer cylindrical surface are coaxial.

The hub bearing unit may be configured such that the at least one groove extends from an axially outer end of the toothed sleeve to an axially inner end of the toothed sleeve and such that an axially length of the at least one groove is greater than an axial length of the toothed profile and such that the axial portion of the radially inner surface is located at an axially inner end of the toothed profile.

The hub bearing unit may alternately be configured such that the at least one groove extends from an axially outer end of the toothed sleeve to a closed groove end axially outward of an axially inner end of the toothed sleeve and such that the axial portion of the radially inner surface is located axially inward of the closed groove end.

### BRIEF DESCRIPTION OF THE DRAWINGS

Embodiments of the invention will now be described with reference to the attached drawings, which are non-limiting.

FIG. 1 is a sectional elevational view of a hub-bearing unit according to a preferred embodiment of the present disclosure.

FIG. 2 is a detail view of a portion of the hub-bearing unit of FIG. 1, showing the portion of the hub before a plastic deformation process is performed.

FIG. 3 is a detail view of a portion of a hub-bearing unit according to a second embodiment of the present disclosure in which the hub is in a configuration preceding a plastic deformation process.

FIG. 4 is a sectional elevational view of another detail of the hub-bearing unit of FIG. 1.

### DETAILED DESCRIPTION

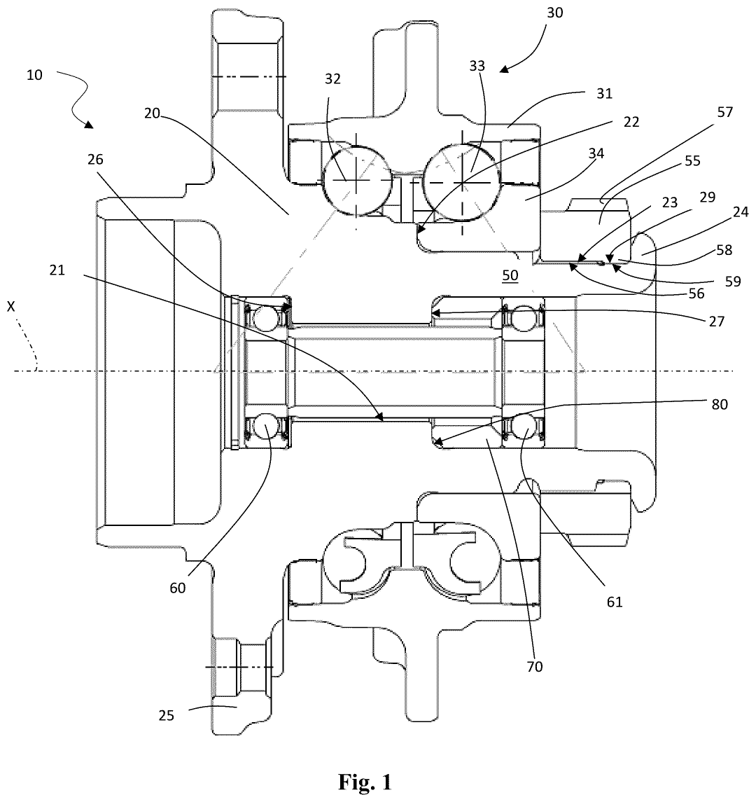

With reference to FIG. 1, a hub-bearing unit according to a preferred embodiment is designated, as a whole, with reference numeral 10.

When in use, the hub-bearing unit 10 is interposed between a wheel and a frame, both of which are known and not illustrated, of the vehicle, and may be coupled selectively to a constant velocity joint, which is also known and not illustrated, via a transmission device, which is also known and not illustrated, for the selective transmission of drive torque to the respective wheel (not illustrated).

The hub-bearing unit comprises a rotatable flanged hub 20 and a bearing unit 30. The bearing unit 30 has a central rotation axis X, a stationary radially outer ring 31, and a radially inner ring 20 defined by a first portion of the flanged hub 20 and a further radially inner ring 34 mounted on and rigidly connected to a second portion of the flanged hub 20. Both of the radially inner rings 20, 34 are rotatable with respect to the radially outer ring 31 as a result of the interposition of two rows of rolling elements 32, 33, in this case balls.

Throughout the present description and in the claims, terms and expressions indicating positions and orientations, such as “radial” and “axial”, are to be understood with reference to the central rotation axis X of the bearing unit 30. On the other hand, expressions such as “axially outer” and “axially inner” refer to the mounted state of the hub-bearing unit, and in this case preferably refer to a wheel side and to a side opposite the wheel side, respectively.

The flanged hub 20 has a central through-hole 21 which extends along the axis X in order to be engaged with the constant velocity joint and comprises, on an axially outer side thereof, a flange 25 for fastening the hub-bearing unit 10 of the wheel of the vehicle, and, on an axially inner side thereof, an end edge 24, rolled by orbital roll forming, which is configured to axially preload both the inner ring 34 and a toothed sleeve 55 against a radially outer shoulder 22 of the flanged hub 20. The toothed sleeve 55 is mounted against the inner ring 34 and is coupled to the flagged hub 20 by way of an internal groove 56 to a toothed profile 23 of the flanged hub 20, and is part of a transmission device configured to be connected to or disconnected from a constant velocity joint by means of an outer toothed profile 57.

Bearings are required between the hub and the constant velocity joint to enable the flanged hub 20 to rotate independently of the constant velocity joint when the flanged hub 20 is disengaged from the constant velocity joint. In the present embodiment, the flanged hub 20 has a first radially inner shoulder 26 and a second radially inner shoulder 27 formed inside the central through-hole 21, close to which are mounted at least two radial ball bearings 60, 61 (two in the configuration illustrated in FIG. 1). The two radial ball bearings 60, 61 are mounted in a radially inner position with respect to the flanged hub 20. In particular, a first radial ball bearing 60 is mounted in an axially outer position against the first shoulder 26 and a second radial ball bearing 61 is mounted in an axially inner position against the second shoulder 27. Optionally, there may also be a second radial ball bearing in the axially inner position.

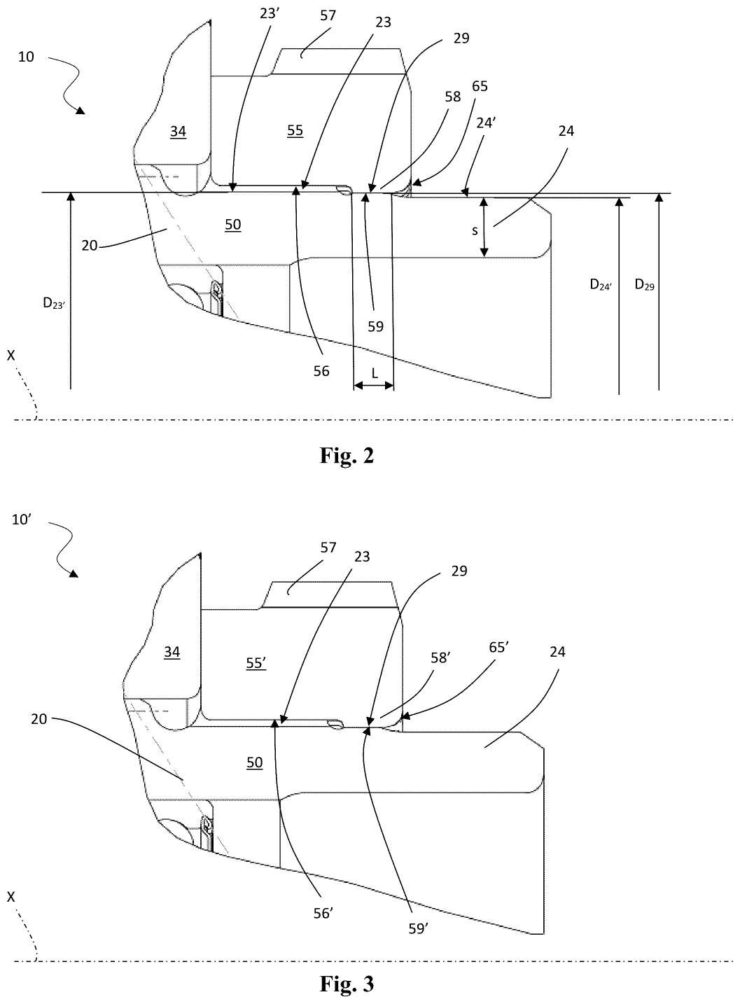

FIG. 2 illustrates an axially inner portion of the hub-bearing unit of FIG. 1, in particular an axially inner tubular portion 50 of the flanged hub 20 and the toothed sleeve 55 at a time before an orbital roll forming operation has been performed on the end of the tubular portion 50 to form the end edge 24.

The internal groove 56 extends axially through the toothed sleeve 55, and the toothed profile 23 of the flanged hub 20 has a smaller axial length than the axial length of the internal groove 56.

The toothed sleeve 55 has an axially and radially inner step 58 having a radially inner, discontinuous cylindrical surface 59 formed by the surfaces of the crests of the internal groove 56. Correspondingly, the tubular portion 50 of the flanged hub 20 has a radially outer cylindrical surface 29. This cylindrical surface 29 is axially inside the toothed profile 23 and axially outside the end edge 24. The two cylindrical surfaces—the cylindrical surface 59 of the step 58 of the toothed sleeve 55 and the cylindrical surface 29 of the tubular portion 50 of the flanged hub 20—are precisely mated to each other to ensure optimal centering of the toothed sleeve 55 with respect to the flanged hub 20.

The improved centering between the two components provide numerous advantages, including improving coaxiality between the flanged hub 20 and the toothed sleeve 55, improving coaxiality between the toothed sleeve 55 and the radial inner ball bearings 60, 61, and improving the mechanical strength of the toothed sleeve 55 in relation to stresses induced by the orbital roll forming operation. In particular, a reduced stress and a reduced radial expansion, by virtue of the greater radial thickness of the toothed sleeve 55 (with respect to known solutions), due to the presence of the step 58.

In addition, the improved centering mitigates the engagement problems of the disconnection system by virtue of the improved centering and the reduced radial expansion of the toothed sleeve 55 and reduces possible vibration and noise problems when the disconnection system is inserted.

Advantageously, the coupling between the two cylindrical surfaces 29, 59 is uncertain: the processing tolerances of the two surfaces can thus define a coupling with “slight” play or a coupling with “slight” interference.

Preferably, the diameter D₂₉ of the centering cylindrical surface 29 of the flanged hub 20 should satisfy the following conditions: the diameter D₂₉ of the cylindrical surface 29 should be smaller than the diameter D_{23′} of a bottom cylindrical surface 23′ of the toothed profile 23 of the flanged hub 20, in order to ensure the feasibility of production of the toothed profile. Even more preferably, the diameter D₂₉ should be at least 0.01 mm smaller than the diameter D_{23′}. In other words:

$${D}_{29} \leq {D}_{{23}^{′}} - 0.01 mm .$$

Also, the diameter D₂₉ of the cylindrical surface 29 should be greater than the diameter D_{24′} of a radially outer cylindrical surface 24′ of the end edge 24 of the flanged hub 20. Even more preferably, the difference between the diameter D₂₉ of the cylindrical surface 29 and the diameter D_{24′} of the surface 24′ should be between 0.1 mm and 1 mm.

When establishing the maximum possible value for the diameter D₂₉ of the cylindrical surface 29, the thickness s of the end edge 24 to be rolled should be taken into account. This thickness is chosen on the basis of the structural requirements of the application and on the orbital roll-forming operating parameters selected for the component.

The axial length L of the centering cylindrical surface 59 of the toothed sleeve 55 should be at least 1 mm. However, account has to be taken of the fact that the maximum axial length L is bound by the axial length of the internal groove 56 of the toothed sleeve 55, the choice of which is dependent on the torque transmission requirements and is defined according to the specifications of the groove standards.

FIG. 3 illustrates a similar axially inner portion of a hub-bearing unit 10′ according to an alternative embodiment. The only difference between the two configurations resides exclusively in the toothed sleeve 55′ and, for that reason, this alternative embodiment of the invention is illustrated by the single detail in FIG. 3, all the remaining features being identical to the embodiment shown in FIGS. 1 and 2.

In this embodiment, the toothed sleeve 55′ has, unlike the case illustrated above, an internal groove 56′ that does not axially pass through and is axially limited by the step 58′. Consequently, the step 58′ has a centering cylindrical surface 59′ that is continuous rather than discontinuous as in the configuration discussed above. Nothing changes with regard to the centering cylindrical surface 29 of the flanged hub 20 or with regard to the design requirements described above.

This embodiment provides a further advantage in addition to those already listed above, namely that an axially inner surface 65′ of the toothed sleeve 55, which supports the rolled end edge 24 of the flanged hub 20, does not exhibit any discontinuity due to empty spaces between the teeth (discontinuity that is, however, present in a corresponding surface 65 of the toothed sleeve 55 of the first embodiment of the invention). The rolled material of the end edge 24 is thus pressed against a continuous surface with no empty spaces (about the full 360° of the circumference). This avoids discontinuity of the material which may cause stresses and potential crack initiation points to be concentrated on the rolled material.

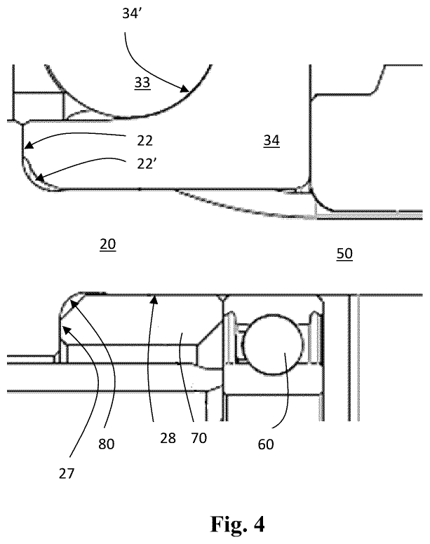

With reference to FIG. 4, both for the embodiment in FIGS. 1 and 2 and for the alternative embodiment in FIG. 3, the axial stop for the second radial ball bearing 61 is advantageously formed by a spacer 70 radially inside the flanged hub 20 and axially outside the radial ball bearing 61. The spacer 70 is in turn axially blocked against the second axial shoulder 27 of the flanged hub 20.

More specifically, the two radial bearings 60, 61 and the spacer 70 are pressed by a ring (known and not illustrated) against the shoulders 26, 27, exerting axial compression forces through the outer rings of the bearings 60, 61 and the spacer 70 onto the flanged hub 20 that, in response to the stresses transmitted by the wheel, generate reaction forces on the shoulders 26, 27 and in particular on the axially inner second shoulder 27, since it is located in the most highly stressed part of the flanged hub 20, i.e. the tubular portion 50.

The presence of the spacer 70 makes it possible to improve the geometry of the flanged hub 20 in terms of tension. Indeed, to enable grinding operations to be carried out on the radially inner seat 28 of the flanged hub 20, the seat accommodating the second radial ball bearing 61 and the spacer 70, a relief groove 80 has to be defined between the seat 28 and the second axial shoulder 27 of the flanged hub 20. The relief groove 80 is therefore axially outside the seat 28 and radially inside the entire flanged hub 20. The presence of the spacer 70 enables the relief groove 80 to be sufficiently distant from the tubular portion 50 of the flanged hub 20.

Consequently, the inclusion of the spacer 70, which is used as an axial shoulder for the axially inner radial ball bearing 61, is primarily intended to enable the provision of a radially inner relief groove 80 that is different in shape and position compared to the relief groove that could be provided without the spacer 70.

The inclusion of the spacer 70 therefore makes it possible to achieve numerous advantages, including: the radially inner relief groove 80 is provided in a more axially outer position, which is therefore further away from the tubular portion 50 of the flanged hub 20, which is the most stressed zone of the hub, and the geometry of the relief groove 80 is characterized by larger radii and a greater overall length, with a consequent reduction in the notch effect. Furthermore, where required by the application, it is also possible to include an axially inner second radial ball bearing beside the first ball bearing without modifying the flanged hub but merely reducing the axial dimension of the spacer 70. The second radial ball bearing may be useful where one ball bearing is not enough to withstand the stresses coming from the constant velocity joint.

In summary, embodiments of the present invention provide improved centering of the toothed sleeve with respect to the flanged hub. This translates into a more robust design and into improved conditions of use of the hub-bearing unit.

In particular, in terms of design, the advantages include improved coaxiality between the flanged hub and the toothed sleeve, improved coaxiality between the toothed sleeve and the radial inner ball bearings, and improved mechanical strength of the toothed sleeve in relation to stresses induced by the orbital roll forming operation.

In addition, the embodiment in FIG. 3 provides the further advantage of the elimination of the concentration of the stresses and of the crack initiation points on the rolled material of the flanged hub during and after the orbital roll forming operation.

Lastly, from the viewpoint of the end user, the present solution makes it possible to improve the procedure for engaging the disconnection system, by virtue of the improved centering and the reduced radial expansion of the toothed sleeve and to reduce possible vibration and noise problems when the disconnection system is inserted, which is a particularly important aspect in the case of application to electric vehicles.

In addition to the embodiment of the invention as described above, it should be understood that there are numerous other variants. It should also be understood that these embodiments are solely exemplary and do not limit the scope of the invention, its applications, or its possible configurations. On the contrary, although the above description enables those skilled in the art to implement the present invention according to at least one exemplary embodiment thereof, it should be understood that numerous variations of the described components are possible, without thereby departing from the scope of the invention as defined in the appended claims, interpreted literally and/or according to their legal equivalents.

What is claimed is:

1. A hub-bearing unit having a rotation axis and comprising:
a stationary radially outer ring,
a hub having a radially outwardly extending flange at an axially outer side and an axially extending tubular portion at an axially inner side and a radially outwardly extending toothed profile at the tubular portion, a portion of the hub being located radially inside the radially outer ring, and the hub being rotatable relative to the radially outer ring about the rotation axis;
a radially inner ring mounted on the hub in axial abutment with a radial external shoulder of the hub,
a toothed sleeve mounted axially inward of the radially inner ring and having a radially inner surface including at least one groove mating with the toothed profile;
wherein the tubular portion includes a radially outer cylindrical surface,
wherein an axial portion of the radially inner surface of the toothed sleeve lies on or is bounded by a first imaginary cylinder,
wherein the axial portion of the radially inner surface engages the radially outer cylindrical surface, and
wherein the first imaginary cylinder and the radially outer cylindrical surface are coaxial.

2. The hub-bearing unit according to claim 1, wherein the axial portion of the radially inner surface comprises a plurality of discrete surface portions lying on the first imaginary cylinder.

3. The hub-bearing unit according to claim 1, wherein the axial portion of the radially inner surface comprises a circumferentially continuous surface.

4. The hub-bearing unit according to claim 1,
wherein the at least one groove extends from an axially outer end of the toothed sleeve to an axially inner end of the toothed sleeve,
wherein an axially length of the at least one groove is greater than an axial length of the toothed profile, and
wherein the axial portion of the radially inner surface is located at an axially inner end of the toothed profile.

5. The hub-bearing unit according to claim 4,
wherein the at least one groove comprises a plurality of grooves forming a radially inwardly directed toothed profile.

6. The hub-bearing unit according to claim 1,
wherein the at least one groove extends from an axially outer end of the toothed sleeve to a closed groove end axially outward of an axially inner end of the toothed sleeve, and
wherein the axial portion of the radially inner surface is located axially inward of the closed groove end.

7. The hub-bearing unit according to claim 1,
wherein the radially outer cylindrical surface is located axially inward of the toothed profile and axially outward of the axially inner end of the tubular portion.

8. The hub-bearing unit according to claim 1,
wherein a diameter of the radially outer cylindrical surface is greater than an outer diameter of the tubular portion at a location axially inward of the radially outer cylindrical surface.

9. The hub-bearing unit according to claim 1,
wherein troughs of the toothed profile lie on a second imaginary cylinder, and
wherein a diameter of the second imaginary cylinder is greater than a diameter of the radially outer cylindrical surface.

10. The hub-bearing unit according to claim 9,
wherein a difference between the diameter of the second imaginary cylinder and the diameter of the radially outer cylindrical surface is between 0.1 mm and 1 mm.

11. The hub-bearing unit according to claim 9,
wherein an axial length of the axial portion of the radially inner surface is greater than or equal to 1 mm.

12. The hub-bearing unit according to claim 1,
wherein the hub includes a radially inner shoulder and a second radially inner shoulder,
wherein a first radial ball bearing is mounted against the first radially inner shoulder,
wherein a spacer is mounted against the second internal shoulder, and
wherein a second radial ball bearing is mounted against the spacer.

13. The hub-bearing unit according to claim 1,
wherein the radially outer cylindrical surface is located axially inward of the toothed profile and axially outward of the axially inner end of the tubular portion,
wherein a diameter of the radially outer cylindrical surface is greater than an outer diameter of the tubular portion at a location axially inward of the radially outer cylindrical surface,
wherein troughs of the toothed profile lie on a second imaginary cylinder, and
wherein a diameter of the second imaginary cylinder is greater than a diameter of the radially outer cylindrical surface.

14. The hub-bearing unit according to claim 13,
wherein the at least one groove extends from an axially outer end of the toothed sleeve to an axially inner end of the toothed sleeve,
wherein an axially length of the at least one groove is greater than an axial length of the toothed profile, and
wherein the axial portion of the radially inner surface is located at an axially inner end of the toothed profile.

15. The hub-bearing unit according to claim 13,
wherein the at least one groove extends from an axially outer end of the toothed sleeve to a closed groove end axially outward of an axially inner end of the toothed sleeve, and
wherein the axial portion of the radially inner surface is located axially inward of the closed groove end.
